(19) United States
(12) Patent Application Publication
(10) Pub. No.: US 2022/0087356 A1
(43) Pub. Date: Mar. 24, 2022

(54) AIR FILTERING SURGICAL HELMET

(71) Applicant: Northwell Health, Inc., New Hyde Park, NY (US)

(72) Inventors: Stanley Asnis, Port Washington, NY (US); Jonathan Danoff, Great Neck, NY (US); Timir Datta-Chaudhuri, New York, NY (US); Todd Goldstein, Albertson, NY (US)

(21) Appl. No.: 17/479,159

(22) Filed: Sep. 20, 2021

Related U.S. Application Data
(60) Provisional application No. 63/081,051, filed on Sep. 21, 2020.

(51) Int. Cl. A42B 3/28; A62B 18/04; A62B 17/04; A42B 3/04; A42B 3/22

(52) U.S. Cl. CPC A42B 3/286; A62B 18/045; A62B 17/04; A42B 3/283; A42B 3/044; A42B 3/225; A42B 3/0453

(57) ABSTRACT

Disclosed is a protective helmet, surgical garment, and positive pressure air filter apparatus. The helmet is adapted to fit on the head of a medical practitioner and includes a filtered air inlet located near the crown of the practitioner's head, one or more air flow ducts, and one or more outlets located near the practitioner's face. The garment fits over the helmet and provides an air-impermeable barrier to prevent airborne contaminants from entering the space around the practitioner's head. A motorized filter unit is adapted to be worn near the waist of the practitioner. A tube connects the output of the filter unit with the air inlet of the helmet to provide a filtered air supply to the practitioner. One or more filter elements are provided at the input of the filter unit. The filter elements remove contaminants, including bacteria, viruses, vapors, and gasses from ambient air drawn into the filter unit to generate filtered air that is delivered to the practitioner.

The present application claims priority under 35 U.S.C. § 119 to U.S. Provisional Patent Application No. 63/081,051, filed on Sep. 21, 2020, which is incorporated herein by reference.

### BACKGROUND

### Field

This disclosure relates to a device for protecting medical practitioners and patients from infection by providing practitioners with a protective head covering that includes a filtered air supply. More particularly, the disclosure relates to an impermeable covering with an air supply that is filtered by drawing air through a filter using a powered blower. The filter may be sufficient to remove bacteria, viruses, smoke, vapors, and gasses from the air supplied to the practitioner.

### Prior Art

Standard surgical helmet/hood and toga/gown systems provide AAMI level 4 protection and can isolate the individual wearing the system from bodily fluids and debris that may be splashed during the course of surgery as well as from the surgical field. Level 4 protection is sufficient to filter bacterial organisms, but not small, airborne viral particles. Thus, the system does not provide an adequate level of protection against airborne biological threats. Commercial powered or non-powered air purifying respirators with appropriate filters can provide protection but are not designed or approved for use within an operating room and are cost-prohibitive to be purchased in bulk.

Some known surgical helmet/hood systems include a fan located within the helmet itself to draw air through the hood material. Locating a fan or other air moving device above the level of the surgical field may cause air currents to flow toward the patient's open incision. These air currents may move bacteria, viruses, and other contaminants into the surgical wound and may increase the chance of infection.

In orthopedics, power instruments are used to cut bone and often debris (bone, blood, marrow, adipose, and other tissues) may be aerosolized from the surgical site. It has been customary for orthopedic surgeons to wear a helmet and toga system. This system consists of a disposable sterile hood placed over the helmet to provide a sterile barrier between the patient's wound and the surgeon. The air that goes into the helmet is drawn through the top of the paper hood. Thus, the paper forming the hood itself acts as a filter. This paper filter may be equivalent to a regular operating room mask that can remove droplets from the air drawn into the hood. The sterile barrier protects the surgical team from these airborne threats. Further, the patient is protected from the surgical team from any bacteria that may be shed by the team as the system provides a fully enclosed barrier between the patient and team member.

While these helmet systems may be an effective system for maintaining sterility of the wound, the paper material that filters air delivered to the surgeon not nearly as protective as filter elements specifically designed to remove very small particles such as an N95 filter or a P100 filter. As a result, these known helmet and toga systems do not protect the surgeon or other operating room personnel from virus or smoke. In the case of orthopedic surgery, electrocautery smoke (sometimes referred to as “Bovie” smoke) is generated when tissues are cauterized and when laser cutting instruments are used. This smoke may be carcinogenic or otherwise harmful to operating room personnel.

With the advent of COVID-19 it was recognized that known helmet/toga systems had the capability to filter bacteria but not viral particles. Moreover, known helmet and toga systems may increase the risk to the individual wearing the system because such systems have the potential to concentrate viral particles within the hood disposed about the face and mucous membranes of the surgeon. In some cases, manufacturers of surgical hoods encourage users to wear tight-fitting goggles under the hood to protect the mucous membranes of the eye from viral exposure.

Best practices for viral protection now encouraged the use of surgical helmet and hood systems with an N-95 or other mask worn directly on the face for personal protection worn inside of the hood. This arrangement creates several issues. The wearer's eyes are not protected from airborne virus particles. The facemask may be uncomfortable, may make the wearer's breathing more difficult, and may impair the wearer from effectively exchanging CO₂. Facemasks may also impair heat exchange via the oral cavity, causing the wearer to feel hot. Facemasks may also obstruct the wearer's field of vision. Facemasks masks may also prevent surgeons from wearing specialized glasses with built in magnification (“loupes”) or glasses that block radiation (“x-ray glasses”) as they may preclude proper fit of these devices on the bridge of the nose.

In addition, facemasks, like the N95 mask, only work properly if there is a good seal against the wearer's face. Maintaining such a seal may be particularly difficult during orthopedic surgery, which may require the surgeon and other personnel to make significant physical movements to manipulate a patient's limbs, to operate saws for cutting bone, to impact metal broaches to shape bone canals, and the like. This physical activity raises a significant potential for the surgical mask to shift, violating its seal. Where the facemask is worn under a helmet and toga system, the wearer cannot easily reseal the facemask.

The length of some orthopedic procedures, such as total joint replacement procedures, also makes comfort of personal protective equipment (PPE) particularly important. Surgeries may be physically demanding and may last a number of hours. Highly effective facemasks, like N95 and P100 masks may not provide sufficient comfort, ease of breathing, and security of seal for these procedures. Even a well-fitted mask may be uncomfortable for long periods of time.

Cost has been a major determinant of the availability of PPE. Often protective equipment like helmet and toga systems must be shared among hospital personnel. At facilities where numerous operating rooms are in use simultaneously, a single helmet may be exchanged many times per day. Decontamination of the helmets between uses may not be practical. The high cost of known helmet and toga systems may prevent some facilities from having an adequate number on hand to accommodate demand and may not allow some systems to be taken out of use to be sterilized.

### SUMMARY

The present disclosure relates to a surgical helmet that addresses these and other difficulties.

According to one aspect of the disclosure, there is provided a surgical helmet that provides a stream of filtered air that is free of, or has a reduced amount of, viruses and bacteria compared with ambient air. This stream of filtered air is generated without requiring effort by the wearer to draw ambient air through the filter element. Such a helmet does not impair the wearer's breathing, does not require a facemask that is sealed against the wearer's face, and does not obstruct the wearer's field of vision.

According to another aspect of the disclosure, there is provided a personal protective system that protects a wearer from bacteria, viruses, vapors, and gasses and does not require a facemask to be sealed against the wearer's face.

According to another aspect of the disclosure, there is provided a surgical helmet that is relatively simple to manufacture and can be produced at a lower cost than known helmet and toga systems.

According to another aspect of the disclosure, there is provided a surgical helmet that can remove gases and vapors, including smoke generated during surgical procedures and provide a stream of air to the wearer that is substantially free of these contaminants.

According to another aspect of the disclosure, there is provided a surgical helmet and personal protective system that protects a wearer from airborne contaminants and does not require the user to wear a close-fitting facemask or goggles to protect mucous membranes.

According to another aspect of the disclosure, there is provided a surgical helmet and personal protective system that includes a device to drive air through a filter element where the air moving device is located below the surgical field and/or at the wearer's back to avoid generating air currents that might carry contaminants into the surgical field. According to another aspect, the device to drive air through the filter element is fixed to the helmet to be worn on the wearer's head and is provided with a filter element that extends upward from the helmet.

According to another aspect of the disclosure, there is provided a surgical helmet and personal protective system that facilitates air flowing past the face of the wearer to flow out from the bottom of the wearer's garment or out from the back of the garment so that the outflow of air is below the level of a surgical field or in a direction away from the surgical field. A system according to embodiments of the present disclosure provides protection to medical personnel when operating in an environment with potential airborne viral and bacterial contaminants and harmful gasses. According to some aspects, such a system works with existing commercial surgical hoods and toga personal protection systems and enhances their capability to supply filtered air. According to some other aspects of the disclosure, there is provided a personal protective system to protect personnel from bacteria, viruses, smoke, vapors, or gasses suitable for use by hospital staff, clinicians, first responders, and lay persons that may be exposed to such contaminants.

According to another aspect of the disclosure, there is provided a surgical helmet and hood system where the hood is readily detachable from a powered air filtration system and wherein the hood incorporates passages to direct air flow to selected parts of the wearer's head and face. According to a further aspect, the hood and air-directing passages are formed from relatively inexpensive materials so that the hood may be disposed of and replaced after a single use, or after a limited number of uses. According to a still further aspect, the air-directing passages are formed integrally with the hood by one or more strips of material joined with an interior surface of the hood to form a duct.

According to some embodiments, the system includes modular components that can be readily adapted to work with commercially available helmets or with a customized helmet according to the disclosure. Helmets according to the disclosure may incorporate components such as head-lamps, digital video cameras, microphones, speakers, heads-up display projectors, head mounted displays, virtual or augmented reality displays, and the like based on application specific needs.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a medical professional wearing a helmet and blower unit of a personal protective system according to an embodiment of the disclosure;

FIG. 2 shows components of the personal protective system of the embodiment of FIG. 1;

FIG. 3 shows another view of a medical professional wearing the personal protective system of FIG. 1;

FIGS. 4A and 4B show a perspective view and a partial cut-away view, respectively, of a blower unit according to an embodiment of the system of FIG. 1;

FIGS. 5A, 5B, and 5C show cross-section views of a blower unit according to the embodiment of FIGS. 4A and 4B;

FIG. 6 is a perspective view of a tube supporting clip for use with embodiments of the disclosure;

FIGS. 7A-7D are perspective views of a helmet portion of a personal protective system according to another embodiment of the disclosure;

FIG. 8 is a block diagram illustrating an electrical circuit used to operate a personal protective system according to embodiments of the disclosure;

FIG. 9A is a perspective view of a personal protective system according to a further embodiment of the disclosure being worn by a person and FIGS. 9B and 9C are cross sections of the embodiment of FIG. 9A;

FIG. 10 is a partial cross section of a hood according to a further embodiment of the disclosure illustrating a duct formed along the inside surface of the hood;

FIG. 11 is a cross section of a duct formed on the inside surface of a hood and supported by a resilient coil according to a still further embodiment of the disclosure; and

FIG. 12 is a view of a duct formed on the inside surface of a hood configured to deliver a flow of air to multiple regions inside the hood according an additional embodiment of the disclosure.

### DETAILED DESCRIPTION

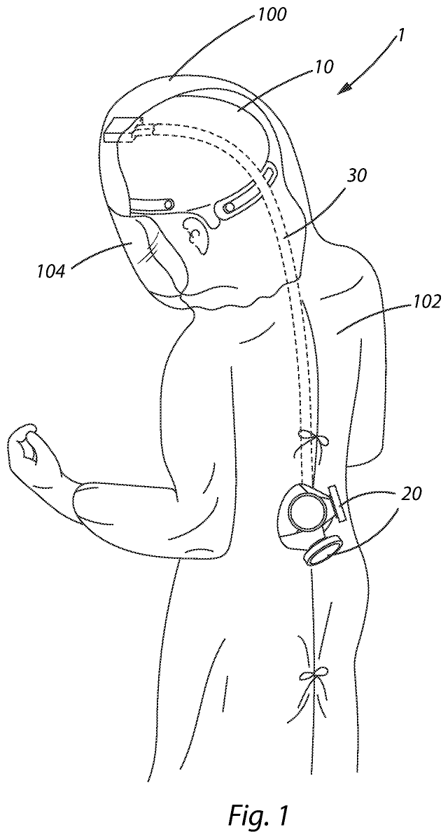

FIG. 1 shows a medical professional wearing a protective hood 100 and protective system 1 according to an embodiment of the disclosure. The hood 100 may be a commercially available surgical hood. Hood 100 includes a transparent face shield 104 positioned in front of, and a short distance away from the face of the wearer. The hood 100 and face shield 104 may be formed from a protective material that reduces or prevents the exchange of liquids, gases, and particles.

The hood 100 may be coupled with a surgical gown or toga 102. According to some embodiments, the hood 100 and toga 102 are hermetically connected with one another to form a continuous impermeable barrier around the wearer's body from the top of the hood, down to the lower hem of the toga 102. According to other embodiments a lower portion of hood 100 is fitted inside the upper portion of toga 102 so that air flowing out of hood 100 flows downward into the space between the wearer and the toga 102 and flows out from below the lower hem of toga 102.

According to alternative embodiments, hood 100 is designed to be worn without a gown or toga. Hood 100 may include a restrictive hem to provide a closed or partially closed fitting round the torso, shoulders, or neck of the wearer. The restrictive hem may be formed by an elastic band, and/or a drawstring to adjust to the size of the wearer's body. Such an embodiment might be used outside of an operating room, for example, by a first responder, where protection of a patient from contamination by the wearer is less critical than during a surgical procedure.

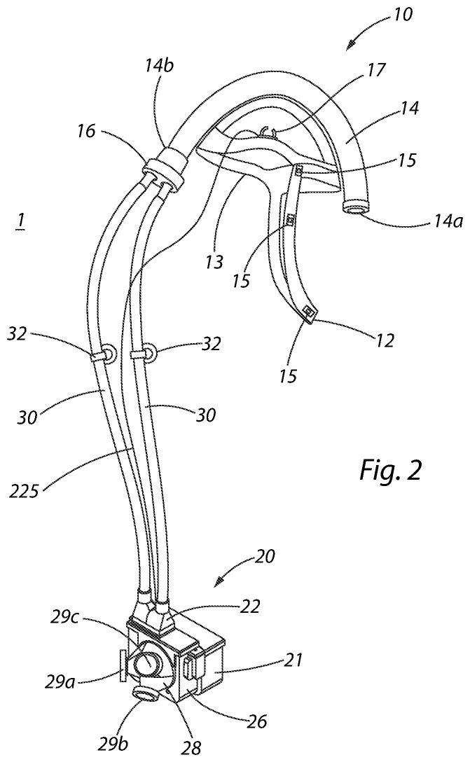

As shown in FIG. 2, the protective system 1 includes a helmet 10 and blower unit or air pump 20 that are connected by one or more tubes or hoses 30. As shown in FIG. 1, helmet 10 is worn under hood 100. Helmet 10 includes a helmet frame 13 that may include one or more attachment points 15 for connecting with and supporting hood 100. Attachment points may include clips, magnetic connectors, snaps, hook-and-loop material patches, Velcro, and the like. Helmet 10 may also include one or more modular connectors 17 for releasably securing accessories, such as a microphone, lamps, cameras, a heads up display, a virtual or augmented reality projector, a communication device such as a telephone, and the like to the helmet 10. According to one embodiment, the accessory includes a heads-up display projector for projecting an overlay image on the inside surface of visor 104. As will be explained below, a wire 225 may be provided from blower unit 20 to helmet 10 to provide electrical power to accessories mounted on modular connector 17. According to one embodiment, helmet 10 comprises a frame structure that adjustably fits on the wearer's head to support the hood and other elements of the disclosure. According to other embodiments, helmet 10 may comprise protective structures, such as elastomeric pads and/or a “hard hat” shell to protect the wearer from impacts, for example, where the device is used by emergency workers administering care in in confined locations. According to other embodiments, helmet 10 comprises other support structures that can be fitted to a wearer's head, including head-rigs known to those of skill in the field of the invention.

According to some embodiments, frame 13 includes a chin guard or bar that forms a scaffold 12 to hold the front part of hood 100 and visor 104 (FIG. 1) a comfortable distance away from the wearer's face. One or more hose clips 32 may be provided along the length of hoses 30 to secure the hoses to the wearer's body. According to other embodiments, instead of or in addition to connecting hose 30 to the wearer's body using a clip 32, one or more sleeves extend along the back of the toga 102. Hoses 30 are disposed within the sleeves.

Duct 14 is provided across the top of frame 13. According to one embodiment, duct 14 extends from the back of the helmet, over the top of the helmet, and ends above the wearer's forehead. Air outlet 14a is provided at the end of duct 14. According to some embodiments, outlet 14a includes features such a louvers that direct air flowing from duct 14 in specific directions, for example, along an inside surface of visor 14 to reduce condensation from accumulating on the visor and/or across the wearer's face. According to other embodiments, outlet 14a includes positionable louvers or secondary ducts that allow the wearer to customize the direction of air flow. This may include one or more ducts to direct airflow along the sides of the wearer's head and/or louvers to provide multiple streams of air across portions of the wearer's face. Duct 14 may also include features that allow the length and direction of the duct to be adjusted to accommodate the size of the wearer's head and the direction of the airflow by, for example, providing a section of flexible “accordion pleats” along the length of the duct.

At the opposite end of duct 14 is air inlet 14b. Inlet 14b is connected with the one or more tubes 30 by fitting 16. In this embodiment two tubes 30 are provided and fitting 16 is a manifold that directs the flow of air from both tubes into duct 14. Tubes 30 may be made from flexible elastomeric tubing to allow helmet 10 to move easily with respect to the rest of the system. According to a preferred embodiment tubes 30 are formed from corrugated ventilator tubing. Fitting 16 provides a hermetic seal between tubes 30 and duct 14. According to one embodiment, instead of a fitting connecting two hoses 30 to inlet 14b. a plurality of inlets 14b in fluid communication with duct 14 are provided with hoses 30 each connected to a respective inlet 14b.

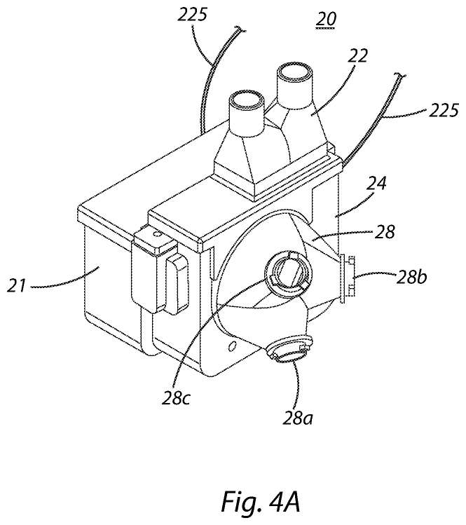

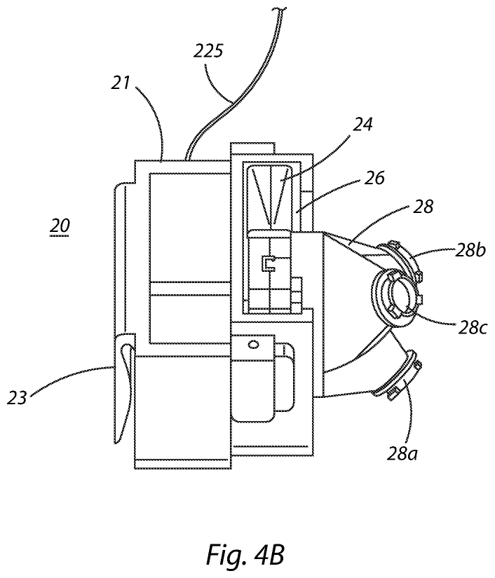

Blower unit 20 is connected to the lower end of tube 30 by fitting 22, which can be seen for example in FIG. 4A. Fitting 22 forms a hermetic seal with tube 30. In this embodiment, fitting 22 forms a manifold to direct the flow of air from blower unit 20 into the two tubes. In the embodiment of FIG. 2, blower 20 includes three filter elements 29a. 29b. 29c connected with the blower.

One or more filter elements 29a. 29b. 29c are selected to remove contaminants from air drawn into blower unit 20 and delivered to helmet 10 via tubes 30. According to some embodiments, the filter elements may be commercially available N95 or P100 filters that remove very small particles from the air, including virus particles and smoke particles. The one or more filter elements 29a-29c may also include substances that adsorb contaminants using activated charcoal. Depending on the types of contaminants expected during use, filters may also include substances that remove radiological contaminants, that reduce or eliminate odors, or that adsorb carbon dioxide or other gasses. According to other embodiments, filters 29a-29c comprise high efficiency particulate air filters, activated carbon filters, electrostatic filters, and/or ultraviolet air purifiers. Filters may also be customized to filter specific types of contaminants. Because air is drawn through the filter elements by a powered blower, no increased effort is required from the wearer to draw air through the filters 29a-29c.

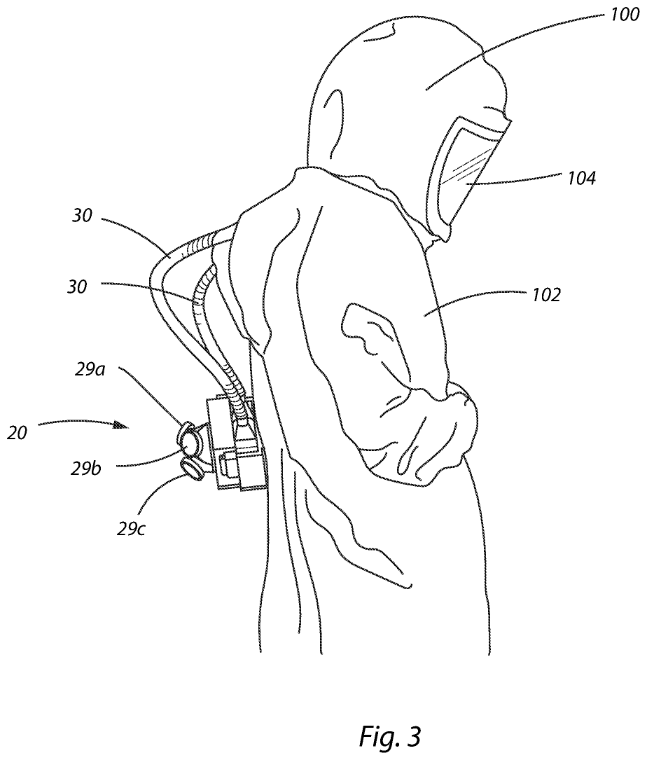

FIG. 3 shows a wearer robed in a hood 100 and tunic 102. Blower unit 20 is positioned adjacent the wearer lumbar spine at the wearer's waist. Blower unit 20 is supported by a belt and/or suspenders located inside tunic and not visible in the figure. According to this embodiment, two tubes 30 connect the blower unit 20 with helmet 10 worn inside hood 100. According to this embodiment, air inlet 14b includes a manifold 16 for connecting the plurality of tubes 30 with the interior of duct 14. Three P100 filter elements are connected with blower unit 20.

FIGS. 4A and 4B show detailed views of blower unit 20. Blower unit 20 includes an electronics housing portion 21, a blower housing or fan enclosure 24, an inlet cavity 26, and a filter manifold 28. Filter manifold 28 includes multiple connector fittings 28a. 28b. 28c adapted to couple inlet cavity 26 with the one or more filter elements 29a. 29b. 29c. For clarity, filters 29a-29c are not shown in FIGS. 4A and 4B. Blower unit 20 may also include belt clip 23. Belt clip 23 is adapted to connect blower unit 20 with a belt worn by the wearer and to support the blower unit 20 comfortably near the wearer's waist. Wire 225 extends from the electrical housing 21 to deliver electrical power to accessories that can be mounted to helmet 10 by modular connectors 17, as shown in FIG. 3. Hose fitting 22 is formed as a manifold for connecting the output of the blower unit 20 to two tubes 30, such as in the embodiment shown in FIG. 3. A smaller or greater number of hoses may be provided with the respective fittings 16 and 22 adapted to the number of hoses. Electronics enclosure 21 holds a source of electrical power and control circuitry, as will be explained below.

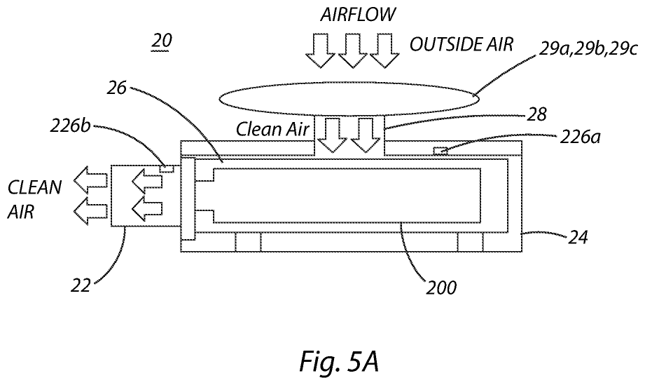

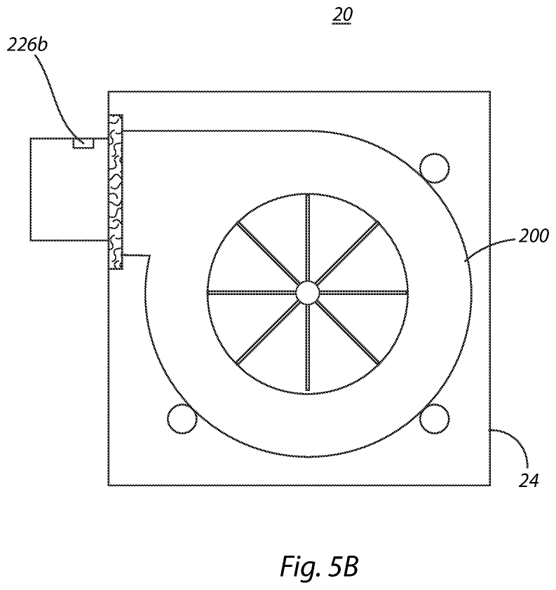

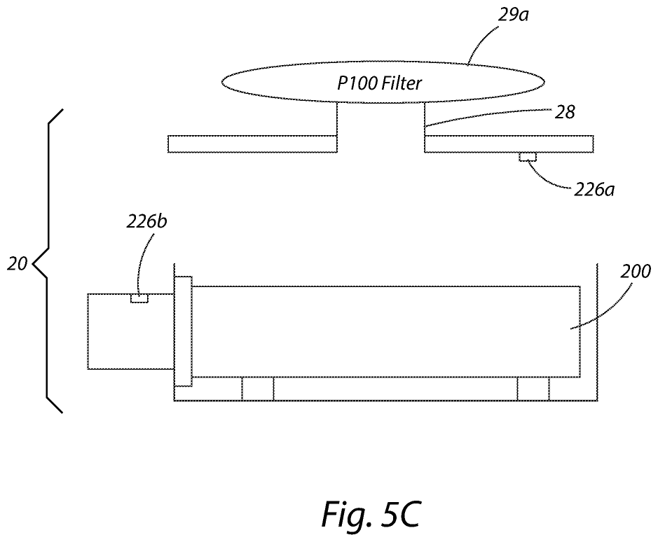

FIGS. 5A, 5B, and 5C are schematic diagrams showing portions of blower unit 20. As shown in FIG. 5A, blower housing 24 encloses an electrically driven blower 200. The inlet of blower 200 is connected with filter manifold 28. The outlet of blower 200 is connected with hose fitting 22. When the blower 200 is energized, ambient air is drawn through filters 29a. 29b. 29c and delivered to helmet 10 via tubes 30. At the inlet side of blower 200, in cavity 26 is an inlet pressure sensor 226a. At the outlet of blower 200 there is an outlet pressure sensor 226b.

In addition to reducing contaminants such as bacteria and viruses from the air supplied to the wearer, an antimicrobial coating may be applied to interior surfaces of the blower housing 24, tubes 30, manifolds 16, 22 and/or duct 14. Certain metals and metal alloys including copper and copper alloys are known to neutralize organisms on contact. According to some embodiments, interior surfaces of system 1 include such antimicrobial coating to further reduce the exposure of the wearer to harmful contaminants.

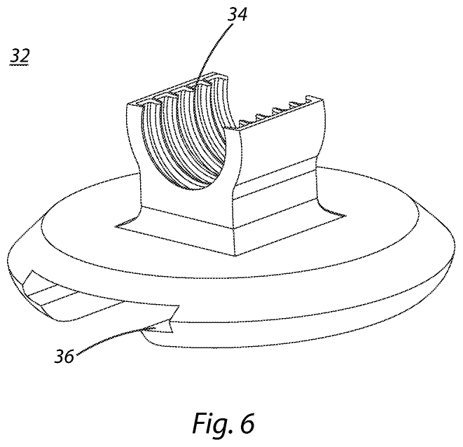

FIG. 6 shows a hose clip 32 for securing hoses 30 to the wearer's body between connectors 16 and 22. Clip 32 includes an engagement slot 34 shaped to releasably hold one or more hoses 30. In the embodiment in FIG. 6 only a single slot 34 is provided. Where more than one hose 30 is used, multiple clips 32 may be provided. Alternatively, a single clip 32 may include a plurality of slots 34. At the side of the clip 32 opposite from slot 34 is a strap connection 36. Strap connection 36 is shaped to secure the hose clip 32 to suspenders or the back of a garment, such as tunic 102, worn by the wearer. According to one embodiment, strap connection 36 is shaped to allow clip 32 to slide up and down along the suspenders to comfortably and securely position the engagement of hoses 30 to the wearer's body.

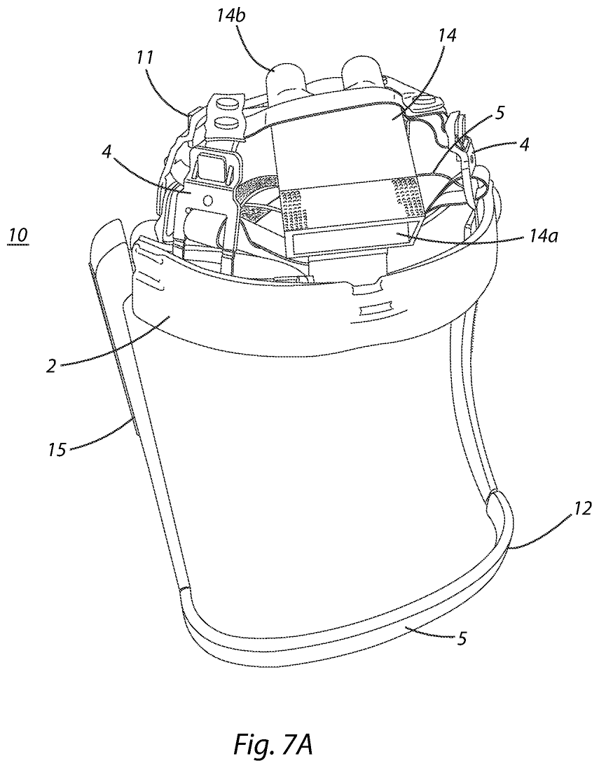

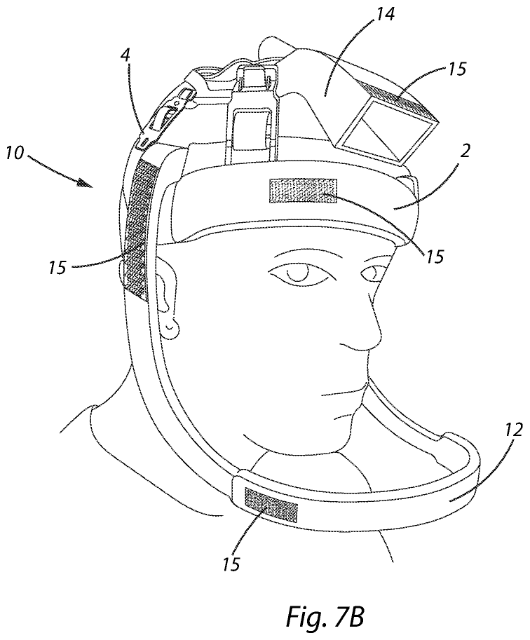

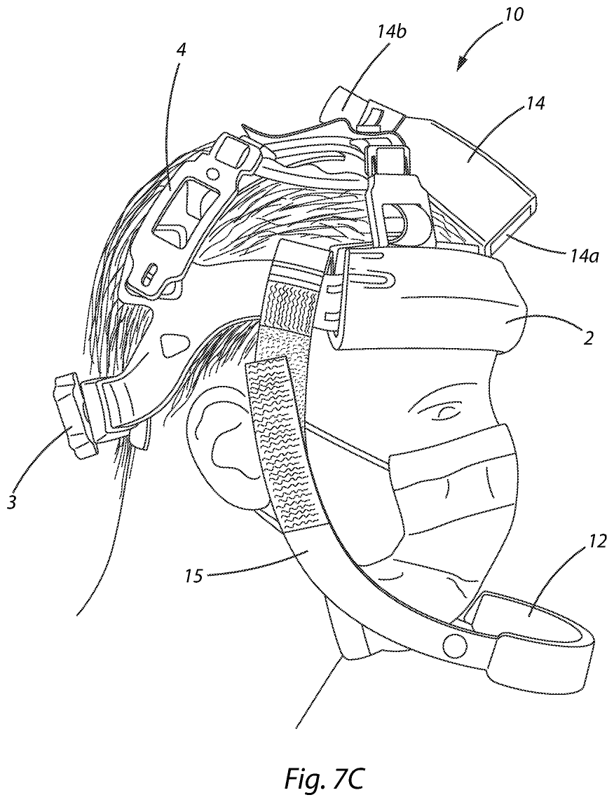

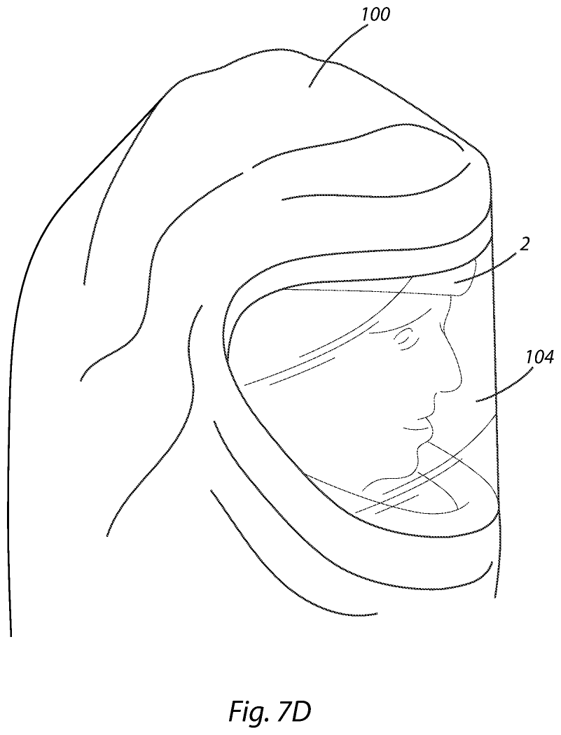

FIGS. 7A-7D show a helmet 10 according to a further embodiment of the disclosure. Helmet 10 includes a headband 2 sized to encircle the wearer's head. According to some embodiments, headband 2 is part of a commercially available surgical headlamp assembly. Headband 2 may include connection points to connect it with other components as discussed below. As shown in FIG. 7C, headband 2 may include a size adjustment 3 to adjust the circumference of the headband to securely fit the helmet to the wearer's head. Helmet 10 includes a frame 4 that extends from the headband 2 across the top of the wearer's head. Duct 14 is connected with headband 2 and frame 4 and is supported on the wearer's head with the output 14a of duct 14 directed to a region in front of the wearer's face. Input manifold 14b is positioned near the rear of the wearer's head and adapted to connect with hoses 30. Attachment points 15, such as hook and loop material, e.g. Velcro, may be located on outwardly facing surfaces of helmet 10, such as along the sides of chin bar 12 and on portions of headband 2, duct 14 and frame 4. Helmet 10 may also include one or more modular connectors (not shown) to hold accessories such as a microphone, a lamp, a camera, a communication device such as a telephone, and the like. According to one embodiment, one or more of the accessories, such as headlamps, are integrated into the structure of helmet 10.

FIG. 7D shows hood 100 positioned over helmet 10. Hood 100 may include mating fastening features adapted to removably connect with attachment points 15 on the helmet. Hood 100 includes a visor 104 positioned in front of the wearer's face. The output of duct 14a directs filtered air along the inside surface of visor 104. This arrangement may reduce the accumulation of moisture on visor 104.

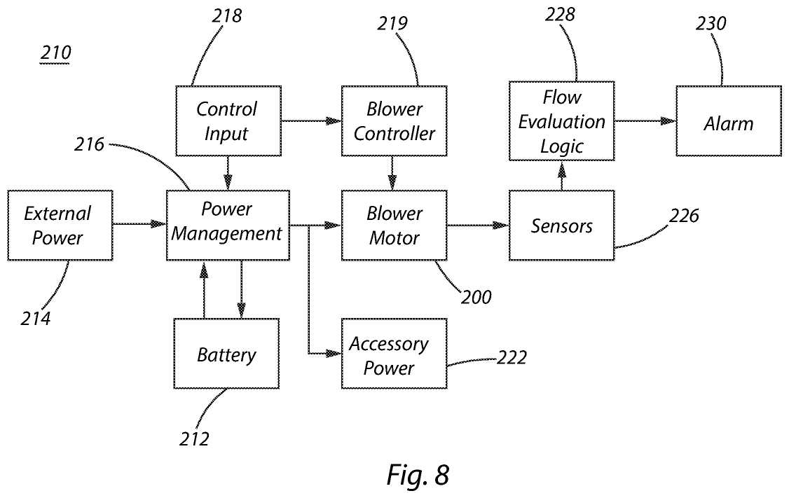

FIG. 8 is a block diagram showing an electronic assembly 210 housed in electronics housing 21 according to some embodiments of the disclosure. The electronic assembly 210 includes a battery 212 to provide power to blower motor 200 and to other electronic components. An external power source 214 may also be provided to deliver current to charge battery 212 and/or to operate the blower unit 20 without battery power. The external power source 214 may be provided via a line voltage adapter connected to a power grid or to another source of electrical power. Power management circuit 216 is connected with battery 212 and external power source 214 and controls the flow of power to and from the battery 214. Power management circuit 216 also provides power to blower motor 200 and to an accessory power circuit 222.

Control input 218 provides an interface that allows the user to control the blower unit 20. Control input 218 may include a switch to turn the blower on and off and a knob or other input to allow a user to adjust the speed of the blower to customize the velocity of air flow to the preference of the user. According to some embodiments, control input 218 also includes an interface to apprise the user of operating parameters of the blower unit 20, such as the time since new filters 29a-c have been installed, the service lifetime of the blower motor 200, and the level of battery charge or expected time until battery recharging is necessary. Control input 218 provides a signal to blower controller 219 to turn on and off blower motor 200 and to adjust the speed of the motor. According to some embodiments, the speed of blower motor 200 is controlled by modulating a current or voltage applied across windings of the motor. According to other embodiments, controller 219 provides a pulse width modulation (PWM) signal applied to a blower controller internal to the blower housing that varies the current or voltage applied across the motor windings.

Sensor package 226 includes air input sensor 226a positioned between filters 29a. 29b. 29c and the blower 200 and air output sensor 226b positioned downstream from the blower as shown in FIGS. 5A-5C. Output from the sensor package 226 is provided to the flow evaluation logic circuit 228.

Flow evaluation logic circuit 228 determines operating characteristics of the system based on signals from the sensor package 226 and detects when an error condition exists. When an error condition is detected, flow evaluation logic circuit 228 sends a signal to alarm 230 to alert the user of the error condition.

Pressure measured at the inflow of the blower 20 by input pressure sensor 226a depends on the ambient atmospheric pressure and on the pressure drop of air pulled through filters 29a-c. This in turn depends on the volume of air drawn through the filters and on the resistance to flow provided by the filters. As the filters 29a-29c accumulate materials that are filtered from the air stream, the resistance may increase as the free surfaces of the filters are covered. According to some embodiments, the input pressure at input pressure sensor 226a is compared with an acceptable range of pressure that indicates a sufficiently low resistance created by the filters. As the filters reach the end of their useful life, the pressure at input pressure sensor 226a may drop below an acceptable threshold and an error signal indicating that the filters need to be replace may be provided to the user via alarm 230. This threshold may be adjusted depending on the speed of the blower motor 200.

Air pressure measure at the outflow of the blower 20 by output sensor 226b may depend on the back pressure created as air flows through tubes 30, duct 14, and out through openings in hood 100 and toga 102. A drop in output pressure may indicate that a leak has developed between the blower unit 20 and the inside of the hood 10 and toga 102, for example, because a hose 30 has become disconnected. Such a drop in output pressure may be detected as a leak error condition and flow evaluation logic circuit 228 may alert the user of the leak via alarm 230.

According to one embodiment, evaluation circuit 228 determines a differential pressure between the air flow upstream from sensor 226a and downstream of the blower 20 from sensor 226b. Based on known aerodynamic parameters for the blower unit 20, the air flow through the blower may be determined by differential pressure between sensors 226a and 226b. When the differential pressure is within acceptable tolerances, and hence, when airflow is within acceptable limits, no error condition exists. According to some embodiments the differential pressure measurement allows detection of various conditions that might affect the performance of the system. These include i) a filter leak condition where incoming air bypasses the filter element; ii) a conduit leak condition where filtered air leaks out from tubes 30 and/or duct 14 before being delivered to the wearer; iii) a filter blockage condition where the flow of incoming air through the filters 29a-c is blocked or diminished as filter is nearing the end of its useful lifetime; and iv) a conduit blocked condition where air flowing through tubes 30 and/or duct 14 is blocked, for example, by a kink in one or more of the hoses 30. According to some embodiments, conditions i) and ii) are detected by determining that flow through the blower unit 20 is in excess of what is expected during normal operation and conditions iii) and iv) are detected by determining that flow through the blower unit 20 is less than what is expected during normal operation.

According to some embodiments, flow evaluation circuit 228 and sensor package 226 are adapted to determine whether the flow of air being delivered to the wearer is above a minimum threshold, for example, 170 liters per minute. According to this embodiment, if the air flow falls below the minimum threshold, a signal is communicated by the wearer via alarm 230 to alert the wearer.

Power management circuit 216 may also provide electrical power to accessory power circuit 222. Accessory power circuit 22 is connected, via wire 225 shown in FIG. 2, to one or more accessories, such as lamps, communications devices, and the like attached to helmet 10 by connector 17.

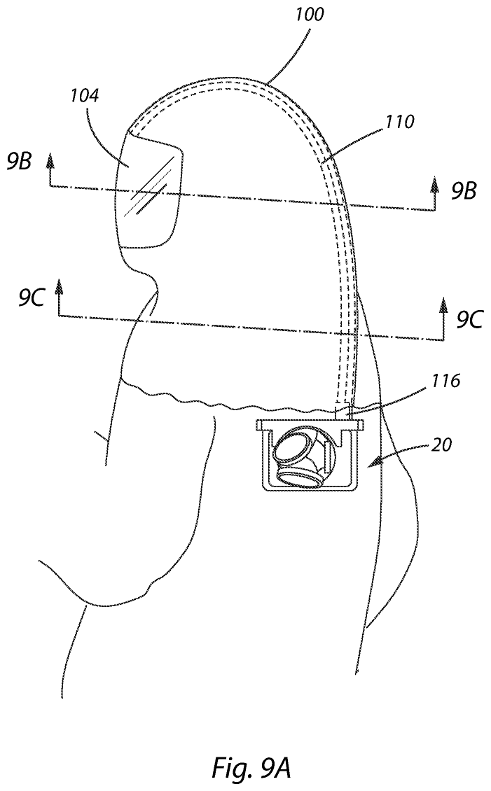

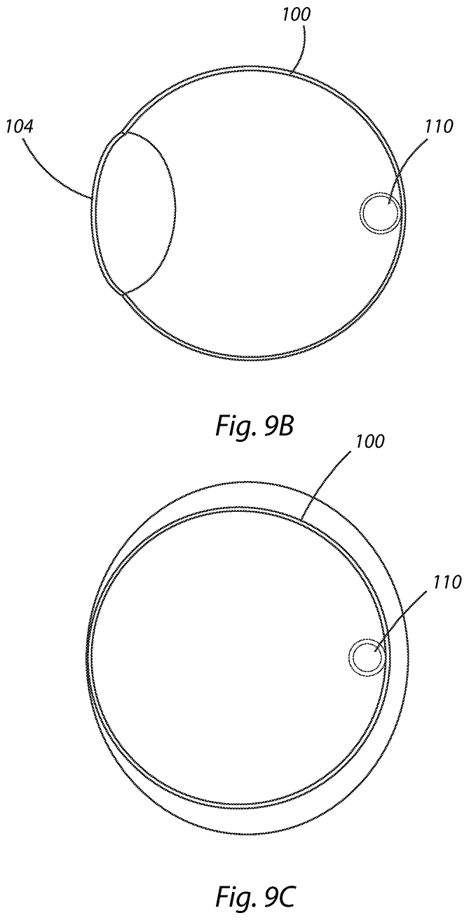

FIGS. 9A-9C show a further embodiment of the disclosure. Hood 100 may be formed from the same materials as discussed for previous embodiments. Visor 104 is affixed to the front of hood 100. Hood 100 may be supported on the wearer's head by a helmet (not visible in Fig. 9A) having the helmet frame 13 as discussed with regard to previous embodiments. Hood 100 includes an integral air duct 110 affixed along an inside surface of hood 100.

FIGS. 9B and 9C show cross sections of the hood 100 and duct 110. According to one embodiment, duct 110 is a section of tubing that is sufficiently flexible so that it does not restrict the wearer's movements. According to one embodiment, the section of tubing forming duct 110 is ventilator tubing including ridges to provide sufficient patency to the duct so that the duct remains open to allow airflow from blower 20 to openings at the distal end of the duct near the wearer's face. The tubing is affixed to the inside surface of hood 100. As with previous embodiments, air directing means, such as louvers, may be provided at the distal end of duct 110 to direct a flow of air across the inside surface of visor 104 to reduce condensation on the visor.

The proximal end of duct 110 is connected with blower 20. According to some embodiments, blower 20 is as described with respect to previous embodiments. A connector 116 is provided to releasably connect the output from blower 20 into the lumen of duct 110. Connector 116 may be a screw connector, a snap-connector, a quick-connect coupling, an interference fit connector between the duct and the blower, or other connector mechanisms known in the field of the invention.

Hood 110 may be formed from a variety of materials including, but not limited to cotton, polyester, polyethylene, nylon, polypropylene, or other fabric. In addition, the material forming hood 110 may be a composite material or blend or laminated of two or more layers of material and may combine porous and non-porous layers. According to one embodiment, hood 110 provides a waterproof barrier that allows transpiration of water vapor to provide breathability. According to one embodiment, the material forming hood 110 conforms to breathability standards established by the FDA, for example, the F2407 guidelines set by the American Society for Testing and Materials (ASTM).

Hood 110, according to this embodiment, may be formed from impermeable material, for example, a polymer film. Such a material would prevent any exchange of gasses through the hood to provide protection in environment where highly toxic gasses or highly bio-hazardous organisms may be present. Hood 100 may be formed from semipermeable material, that allows the exchange of some gasses, for example, water vapor, to enhance the comfort of the wearer by reducing humidity within the hood. Such materials may be suitable where protection from microorganisms is required, for example, an operating theater. Hood 100 may also be formed from relatively permeable material, for example, a woven fabric.

According to one embodiment, hood 100 is formed from a relatively inexpensive material, such as paper coated with a polymer coating to provide a selected permeability and other characteristics that will be discussed below. Likewise, duct 110 and visor 104 are formed from relatively inexpensive components so that the assembly of hood 100, duct 110 and visor 104 form a disposable component.

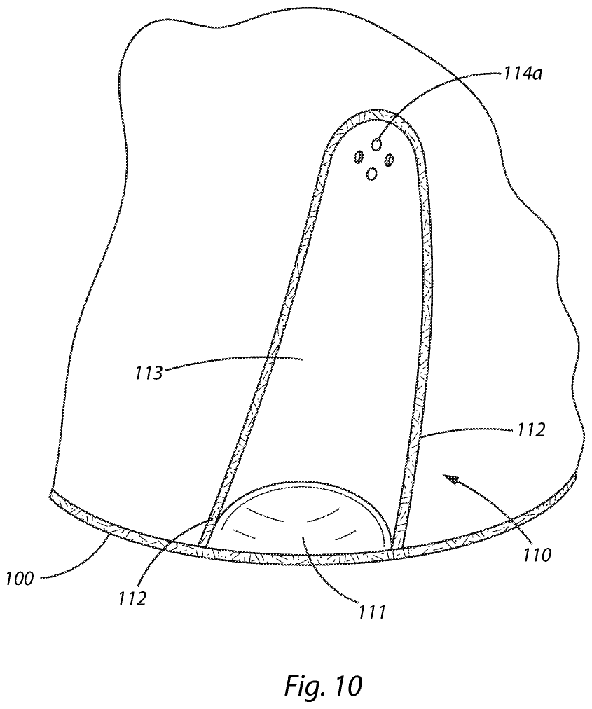

FIG. 10 is a view of a portion of the inside surface of hood with a partial cross section showing duct 110 formed along the inside surface of hood 100 according to another embodiment of the disclosure. In this embodiment, duct 110 is formed by a material strip 113. The material strip is bonded to the inside surface of hood 100 by seams 112 to form an air-tight bond between the hood and the strip. Lumen 111 is formed between the hood 100 and the material strip 113 to form duct 110. According to one embodiment, seams 112 are formed by an adhesive, by heat welding, by sewing, or by other methods known to those of skill in the field of the invention. Material strip 113 may be formed from the same material as hood 100. According to a preferred embodiment, seams 112 are formed by fusing the polymer coatings of the strip and hood material to create an air-tight bond. According to one embodiment, hood 100 and strip 113 are formed from a polymer coated paper or non-woven fabric.

One or more holes or openings 114a are formed through material strip 113 at the distal end of duct 110. Openings 114a are positioned to direct air flowing through duct 110 toward the face of the wearer, toward the inside surface of visor 104, or to both the visor 104 and the wearer's face. The output of blower 20 and the sizes and numbers of openings 114a are selected so that a sufficient backpressure is maintained inside lumen 111 to hold duct 110 open.

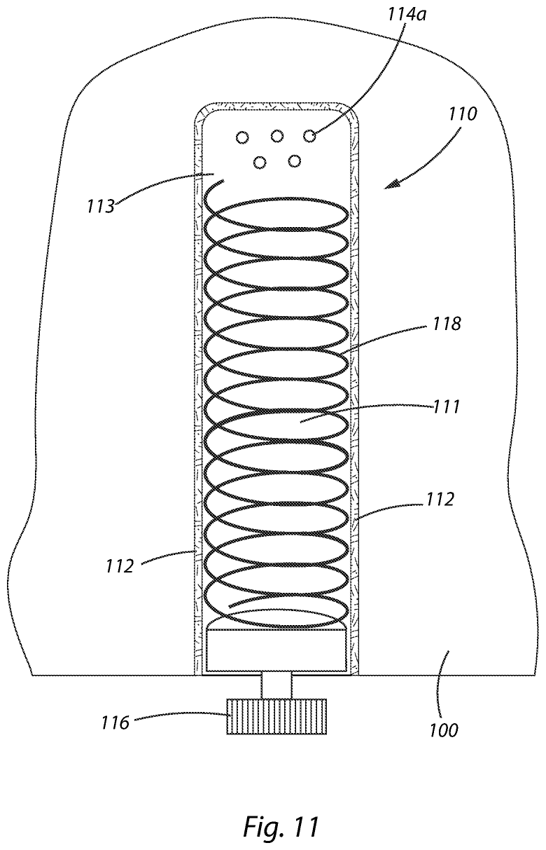

FIG. 11 shows a duct 110 formed along the inside surface of hood 100 according to another embodiment of the disclosure. As with the previous embodiments strip 113 is joined with hood 100 along seam 112 to form an air-tight bond. In this embodiment, resilient coil 118 is provided within the lumen 111 of duct 110. Coil 118 is made from a resilient material, for example, a metal alloy that can be elastically compressed, for example, when hood 100 is packaged for delivery to the user, and that regains its expanded shape when the hood is removed from its packaging. Coil 118 is sized to hold the lumen 111 open to allow air to flow freely from blower 20 to openings 114a for delivery to the wearer.

According to one embodiment, wire 225 from the blower unit 20, as shown in FIGS. 4A and 4B, is connected with a proximal end of coil 118. According to this embodiment, coil 118 is a conductive material. Accessories such as lamps, microphones, communication device and the like, that are supported on the helmet by modular connectors 17, as shown in FIG. 2, are connected with coil 118 at one or more points along the coil to deliver power to the accessories.

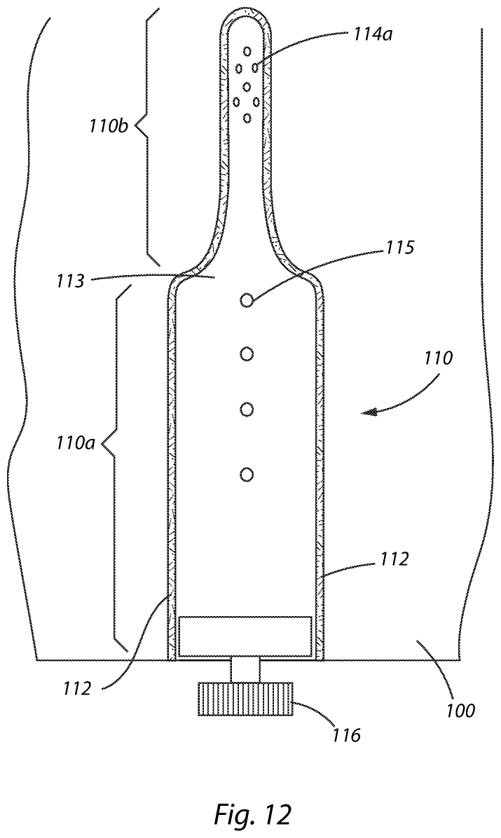

FIG. 12 shows a further embodiment of duct 110. In this embodiment, duct 110 includes a wide proximal portion 110a and a narrower distal portion 110b. In addition to openings 114a at the distal end of the duct that are positioned to deliver a flow of air to or near the wearer's face, in this embodiment, additional openings 115 are provided. Openings 115 may be positioned to direct air to the crown of the wearer's head, or to the sides of the user's face to provide additional cooling for the wearer. The widths of proximal and distal sections 110a, 110b of duct 110 are selected so that sufficient air flow velocity at the distal end is maintained, despite the diversion of a portion of the flow through additional openings 115.

The disclosure is not limited to the arrangement of strip 113 and the corresponding shape of duct 110 shown in the figures. Strip 113 may be shaped and bonded with hood 100 to direct airflow to various locations inside hood 100. For example, duct 110 could be formed with one or more branches extending toward the sides of the wearer's head to direct airflow to the sides of the wearer's face.

While illustrative embodiments of the disclosure have been described and illustrated above, it should be understood that these are exemplary of the disclosure and are not to be considered as limiting. Additions, deletions, substitutions, and other modifications can be made without departing from the spirit or scope of the disclosure. Accordingly, the disclosure is not to be considered as limited by the foregoing description.

We claim:

1. A protective surgical helmet comprising:
a helmet frame adapted to fit on a head of a human;
a hood fitted over the frame, wherein an interior space of the hood encloses the head;
a duct connected with the frame and having an air inlet and an air outlet, wherein the air outlet is positioned to direct a flow of filtered air into the interior space;
an air conduit connected at a proximal end with the air inlet; and
a filter unit connected with a distal end of the conduit and defining a fluid path for delivering the flow of filtered air from an ambient environment to the conduit, wherein the filter unit comprises:
one or more filter elements, the filter elements disposed along the fluid path; and
an air pump connected with the filter elements and disposed along the fluid path, wherein the pump moves air from the ambient environment through the filter elements to generate the flow of filtered air.

2. The helmet of clam 1, wherein the filter unit comprises a housing, wherein an input side of the filter elements is exposed to the ambient environment, wherein an output side of the filter elements is connected with an interior space of the housing, wherein an input side of the air pump is connected with the interior space, and wherein an output side of the pump is connected with the distal end of the conduit.

3. The helmet of claim 1, wherein the filter unit is adapted to be worn adjacent to a back of the human, wherein the air inlet is positioned adjacent a crown of the head of the human, and wherein the conduit extends substantially vertically from the filter unit to the crown.

4. The helmet of claim 1, wherein the air outlet comprises a louver adjacent a forehead of the human at a proximal end of the duct.

5. The helmet of claim 1, wherein the helmet frame further comprises a scaffold extending outward from the frame inside the hood, wherein the scaffold holds a portion of the hood away from a face of the human.

6. The helmet of claim 1, further comprising a removable accessory attachable to the frame, wherein the accessory comprises one or more of a light source, a camera, a microphone, and a headphone.

7. The helmet of claim 1, wherein the hood is adapted to engage with a surgical gown, wherein the interior space of the hood is in fluid communication with an interior space of the gown, and wherein filtered air flowing into the hood flows through the gown and out of the gown below a hem of the gown.

8. The helmet of claim 1, wherein the filter elements are selected from one or more of a high efficiency particulate air filter, an activated carbon filter, an electrostatic filter, and an ultraviolet air purifier.

9. The helmet of claim 2, further comprising an antimicrobial coating along an inside surface of the housing, pump, conduit, or duct.

10. The helmet of claim 9, wherein the antimicrobial coating comprises one or more of copper or an alloy of copper.

11. The helmet of claim 2, further comprising an input pressure sensor in fluid communication with the interior of the housing at the input of the pump and a controller connected with the pressure sensor and with the pump, wherein the pressure sensor detects an input air pressure.

12. The helmet of claim 11, further comprising an output pressure sensor in fluid communication with the output of the pump to detect an output pressure and connected with the controller, wherein the controller monitors the input air pressure and the output air pressure to detect an error condition, wherein the controller further comprises an alert signal, and wherein, when the error condition is detected, the controller activates the alert signal.

13. The helmet of claim 12, wherein the error condition comprises one or more of a filter blocked condition, a filter input leak condition, a low airflow condition, a conduit leak condition, and a conduit blocked condition.

14. The helmet of claim 4, wherein the hood further comprises a transparent face plate, wherein the louver is positioned and configured to direct filtered air along an interior surface of the faceplate.

15. A protective system comprising:
a hood configured to at least partially enclose a head of a human, the hood including a length of a material strip attached to and extending along an inside surface of the hood such that a lumen is formed between the inside surface of the hood and the material strip, wherein the lumen forms an air duct having an air inlet and an air outlet, wherein the air outlet is positioned to direct a flow of filtered air in a downward direction;
an air conduit connected at a proximal end with the air inlet of the air duct; and
a filter unit connected with a distal end of the conduit and defining a fluid path for delivering the flow of filtered air from an ambient environment to the conduit, wherein the filter unit comprises:
one or more filter elements, the filter elements disposed along the fluid path; and
an air pump connected with the filter elements and disposed along the fluid path, wherein the pump moves air from the ambient environment through the filter elements to generate the flow of filtered air.

16. The system of claim 15, wherein the hood and the material strip are formed from an identical material, and wherein the strip is attached to the inside surface of the shroud by seams extending along outer edges of the strip and forming an air-tight bond between the strip and the shroud.

17. The system of claim 15 further comprising a coil member disposed within the lumen and dimensioned to hold the lumen in an open configuration.

18. The system of claim 15, wherein the air duct has a proximal end and a distal end, wherein the distal end comprises the air outlet formed as one or more openings or as one or more louvers to direct the flow of filtered air towards a face of the human, and wherein the proximal end is connected to the air conduit in an air-tight manner.

19. The system of claim 15, wherein the air duct includes a wide proximal portion and a narrow distal portion and one or more venting holes disposed between the proximal and distal ends of the air duct to direct the flow of filtered air onto the head or sides of the face of the human.

20. The system of claim 15, wherein the filter unit is adapted to be worn adjacent a back of the human, wherein the hood is adapted to engage with a surgical gown, and wherein the filter elements are selected from one or more of a high efficiency particulate air filter, an activated carbon filter, an electrostatic filter, and an ultraviolet air purifier.
